(19) United States
(12) Patent Application Publication
(10) Pub. No.: US 2026/0172401 A1
(43) Pub. Date: Jun. 18, 2026

(54) MAINTAINING SECURITY AND PRIVACY IN DATA PACKET TRANSMISSION BY OMISSION OF ADDRESSES

(71) Applicant: Abdullah Ali Mohammed Bahattab, Jeddah (SA)

(72) Inventor: Abdullah Ali Mohammed Bahattab, Jeddah (SA)

(21) Appl. No.: 18/981,556

(22) Filed: Dec. 15, 2024

(51) Int. Cl. H04L 9/40; H04L 45/74

(52) U.S. Cl. CPC H04L 63/0428; H04L 45/74; H04L 63/166

(57) ABSTRACT

The present invention relates generally to a system and a method for transmission of data packets in a communications network wherein, the data packet includes data, a transfer route, a source address, a destination address and transport layer addresses. The transmission of data packets between a source and a destination is performed while maintaining security and privacy by stripping of the source address, the destination address and the transport layer addresses before transmission of the data packet from the source to the destination.

### FIELD OF THE INVENTION

The present invention relates to the field of packet-based data transmission of frames/data packets in a communications network while maintaining security and privacy.

### BACKGROUND OF THE INVENTION

There has been an enormous growth in networking and data communication between the network devices. The growth of networking infrastructure with many such technological innovations, has led to the parallel increase in security and privacy of data at different levels of communication. The communication links and interfaces have become targeted platform for various security attacks.

In the IP protocol different types of attacks are performed during the data transmission like spoofing and flooding of data packets, packet dropping, packet sniffing, packet modification etc.

Current technologies like Virtual Private Network (VPN), overcome the privacy issues by maintaining two pairs of source and destination IP addresses. The first pair is the private source and destination IP addresses which will be encrypted along with the data. The second pair is the outer IP addresses which will be used for routing. But, VPNs are insecure because they expose entire networks to threats like malware, DDoS attacks, and spoofing attacks. Once an attacker has breached the network through a compromised device, the entire network can be brought down.

Therefore, there is a need for maintaining security and privacy during the data packet transmission within a network.

### SUMMARY OF THE INVENTION

This invention overcomes the disadvantages of the prior art/conventional/traditional systems/methods by providing advanced technical solutions based on a novel approach in data packets/frames transmission in a communications network.

While in transmission between a source and a destination, most of the IP packets go through different networking devices which have different Network Interfaces, such as, for example, packet forwarding routers, nodes, packet handling devices, network devices etc. Various attacks like snooping, address theft etc. are performed during the transmission. Thus making the packet routing systems vulnerable to these attacks. The present invention maintains security and privacy within the IP packet by eliminating the addresses from the data packets while transmitting between a source and a destination.

The invention provides a method for transmitting data packets/frames between a source and a destination in a network while maintaining security and privacy, the method comprising steps, initiating a transmission session at the source to transmit a data packet to the destination, wherein the data packet contains data, a source address, a destination address and a plurality of transport layer addresses; transmitting the data packet to the destination through a transfer route (path, tags, indexes etc. instead of IP addresses) based on one or more intermediate network devices; receiving the transmitted data packet at the destination; initiating the transmission session at the destination to transmit back the data packet to the source; removing the source address, the destination address and the plurality of transport layer addresses from the data packet at the destination; transmitting back the data packet from the destination to the source through the transfer route based on the one or more intermediate network devices; receiving the data packet at the source; and initiating data packet transmission from the source to the destination without the source address, the destination address and the plurality of transport layer addresses.

### BRIEF DESCRIPTION OF THE DRAWINGS

Various embodiments of a method for transmitting data packets/frames between a source and a destination in a network while maintaining security and privacy are described below. The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings. In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

FIGS. 1A and 1B shows modification in data packet while in transmission between source and destination.

FIG. 2 shows a flow chart of a data packet/frame transmission process in a communications network while maintaining security and privacy according to an embodiment of the invention.

### DETAILED DESCRIPTION OF THE INVENTION

Various embodiments now will be described more fully hereinafter with reference to the accompanying drawings. It should be understood that the invention may be embodied in many different forms and should not be construed as limited to the embodiments set forth herein. The following detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention. It should be understood that the drawings are diagrammatic and schematic representations of exemplary embodiments of the invention, and are not limiting of the present invention nor are they necessarily drawn to scale.

The following detailed description is directed towards systems and methods for transmitting data packets/frames between a source and a destination in a network while maintaining security and privacy. The source and destination can be but not limited to workstations, devices or apparatus.

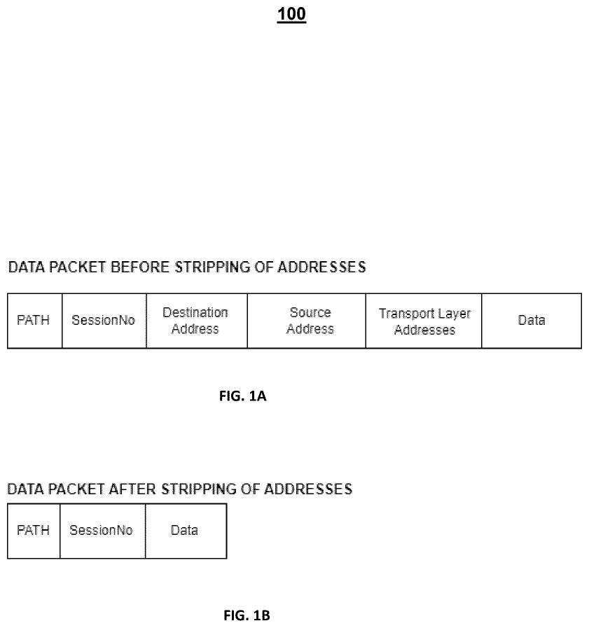

FIGS. 1A and 1B. depicts modification of the frame/data packet while in transmission between a source (not shown) and a destination (not shown). Initially the frame/data packet contains a path or a transfer route, data, a source address, a destination address and a plurality of transport layer addresses and while in transmission of the frame/data packet between the source and the destination, it is modified by removing the source address, the destination address and the plurality of transport layer addresses in order to maintain security and privacy.

In some embodiments, the packet can be but not limited to a frame, a data packet etc. In some embodiments in order for a packet to reach from a source to a destination it is passed through different networking nodes/devices such as switches (distribution, access, and core switches)/routers.

In some embodiments packet based data transmission in wireless and wired communication networks, may include the addresses of the source and destination. The data packet may also include transport layer addresses.

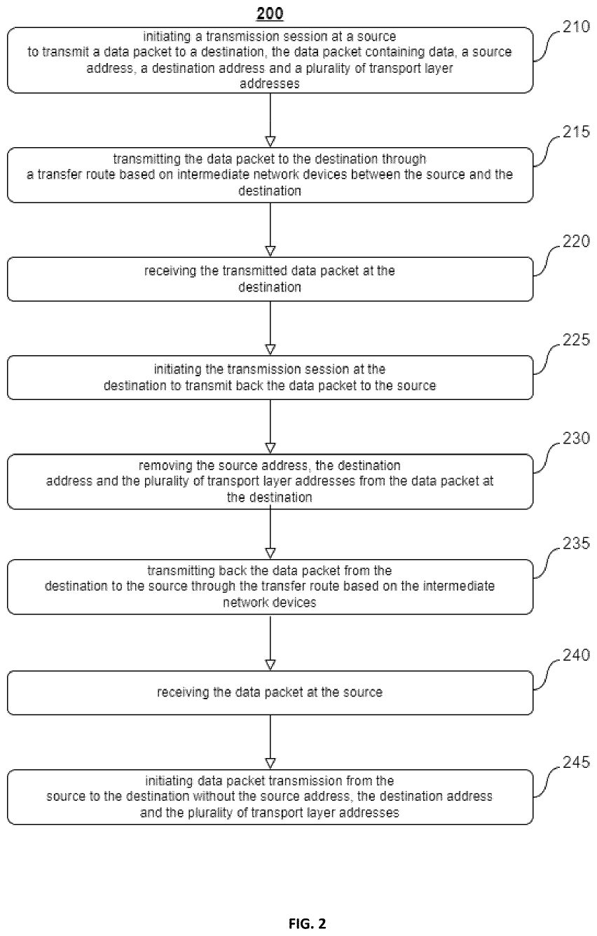

FIG. 2. is a flowchart of a data packet/frame transmission process in a communications network while maintaining security and privacy network according to some implementations.

At step 210, the transmission process 200 can include initiating a transmission session at the source to transmit a data packet to the destination, wherein the data packet contains data, a source address, a destination address and a plurality of transport layer addresses. In some implementations, the data packet can be but not limited to a frame, a packet, an IP packet or a data stream.

At step 215, the transmission process 200 can include transmitting the data packet to the destination through a transfer route based on one or more intermediate network devices. In some embodiments, the source and the destination can be but not limited to a workstation, a PC, a device or an apparatus. In some implementations the intermediate network nodes can be but not limited to packet handling devices, switches or routers.

At step 220, the transmission process 200 can include receiving the transmitted data packet at the destination. In some implementations the transmission process 200 sends a first packet as an initiation packet.

At step 225, the transmission process 200 can include initiating the transmission session at the destination to transmit back the data packet to the source. In some implementations the transmitted data packet is the initiation packet transmitted back to the source as an acknowledgement packet.

At step 230, the transmission process 200 can include removing the source address, the destination address and the plurality of transport layer addresses from the data packet at the destination.

At step 235, the transmission process 200 can include transmitting back the data packet from the destination to the source through the transfer route based on the one or more intermediate network devices. In some implementations the transfer route is determined based on the path through which the acknowledgement packet received from the destination.

At step 240, the transmission process 200 can include receiving the data packet at the source. In some implementations the received data packet cab be but not limited to an acknowledgement packet or transmission initiation packet etc.

At step 245, the transmission process 200 can include initiating data packet transmission from the source to the destination without the source address, the destination address and the plurality of transport layer addresses. In some implementations the transmission of the data packet with data and without the source address, the destination address and the plurality of transport layer addresses is initiated only after the acknowledgement packet received at the source.

In some embodiments, the system or method of data packet transmission further includes identifying the addresses of the intermediate network devices before the transmission of the data packets between the source and the destination.

In some embodiments, the data in the data packet is encrypted/compressed by using encryption/compression/cryptographic technologies at the source before transmitting to the destination and the encrypted/compressed frame can only be decrypted/decompressed only at the destination to maintain data security, privacy and integrity.

In some embodiments, the plurality of transport layer addresses includes but not limited to source transport layer address and destination transport layer address.

In some embodiments, the frames/data packets do not necessarily receive at the destination in the same order as in the order in which the frames/data packets transmitted from the source.

In some embodiments, various protocols can be implemented in the data packet transmission including but not limited to the Route Once And Cross-Connect Many (ROACM), the segment routing, the Multiprotocol Label Switching (MPLS) or the cut through switching etc.

In some embodiments of the invention can further comprise a computer program having a program code for performing one of the above described methods when the computer program is executed on a computer or processor.

In some embodiments, the transfer route is determined by transmitting an establish connection packet from the source to the destination or a centralized control plane through the one or more intermediate network devices towards the destination.

In some embodiments, the transfer route is determined by swapping one or more tags or ports or indices from the source to the destination through the one or more intermediate network devices towards the destination.

In some embodiments, the transfer route is predetermined or generated based on the path of the initiation packet transmitted from the source to the destination through the network devices. The transfer route for the transmission of the data packet having data and without the source address, the destination address and the transport layer addresses is determined after the acknowledgement data packet received from the destination to the source.

In some embodiments, the destination transport layer address further comprises but not limited to port numbers of network services such as web with the value of 80 or DNS with the value of 53.

In some embodiments, the communication network can be but not limited to a Local Area Network (LAN), a Wide Area network (WAN), a wireless communications network, a wired communications network or a Radio Access Network.

In some embodiments, the one or more intermediate network devices can be but not limited to nodes, network nodes, packet handling devices, switches, ad hoc devices, satellite communication devices or routers.

In some embodiments, the source address and the destination address is considered as personal information which may include information about personal details and information about private contents. The personal information may include a source Internet protocol (IP) address and a destination IP address.

In some embodiments, wireless networks may be deployed to provide various types of communication to multiple users through the air using electromagnetic waves. As a result, various types of communication may be provided to multiple users without cables, wires, or other physical electric conductors to couple devices in the wireless network. Examples of the various types of communication that may be provided by wireless networks include voice communication, data communication, multimedia services, etc.

In some embodiments, an example of a wireless network is a wireless local area network (WLAN), WLANs may include stations and/or access points (APs) that may communicate over a plurality of wireless channels. As used herein, an AP is a networking hardware device that allows a wireless-compliant device (e.g., a station) to connect to a network.

In some embodiments, wireless networks such as WLANs such as those defined in the IEEE wireless communications standards, e.g., IEEE 802.11a, IEEE 802.11n, IEEE 802.11ac can use various wireless communication technologies.

In some embodiments, the transmission and receiving of data packets may be performed in accordance with Internet Protocol version 6 (IPv6). IPv6 is a communication protocol that provides an identification and location system for computing devices on networks, and routes traffic across the Internet.

In addition, while a particular feature or aspect of an embodiment of the invention may have been disclosed with respect to only one of several implementations, such feature or aspect may be combined with one or more other features or aspects of the other implementations as may be desired and advantageous for any given or particular application. Furthermore, to the extent that the terms “include”, “have”, “with”, or other variants thereof are used in either the detailed description or the claims, such terms are intended to be inclusive in a manner similar to the term “comprise”. Furthermore, it should be understood that embodiments of the invention may be implemented in discrete circuits, partially integrated circuits or fully integrated circuits or programming means. Also, the term “exemplary” is merely meant as an example, rather than the best or optimal. It is also to be appreciated that features and/or elements depicted herein are illustrated with particular dimensions relative to one another for purposes of simplicity and ease of understanding, and that actual dimensions may differ substantially from that illustrated herein.

The functions of the various elements shown in the Figures, including any functional blocks labelled as “means”, “means for receiving”, “means for inspecting”, “means for determining”, “means for forwarding”, etc., may be provided through the use of dedicated hardware, such as “a receiver”, “an inspector”, “a determiner”, “a forwarder”, “a processor”, “a controller”, “a DSP”, etc. as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included. Similarly, any switches shown in the Figures are conceptual only. Their function may be carried out through the operation of program logic, through dedicated logic, through the interaction of program control and dedicated logic, or even manually, the particular technique being selectable by the implementer as more specifically understood from the context.

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as magnetic disks and magnetic tapes, hard drives, or optically readable digital data storage media. The embodiments are also intended to cover computers programmed to perform said steps of the above-described methods.

The description and drawings merely illustrate the principles of the invention. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

Furthermore, the claimed subject matter is not limited to implementations that solve any or all disadvantages noted in any part of this disclosure. Various modifications and changes can be made to the subject matter described herein without following the example configurations and applications illustrated and described, and without departing from the true spirit and scope of the present invention, which is set forth in the following claims.

I/We claim:

1. A method for transmitting data packets/frames between a source and a destination in a network while maintaining security and privacy, the method comprising steps of:
a. initiating a transmission session at the source to transmit a data packet to the destination, wherein the data packet contains data, a source address, a destination address and a plurality of transport layer addresses;
b. transmitting the data packet to the destination through a transfer route based on one or more intermediate network devices;
c. receiving the transmitted data packet at the destination;
d. initiating the transmission session at the destination to transmit back the data packet to the source;
e. removing the source address, the destination address and the plurality of transport layer addresses from the data packet at the destination;
f. transmitting back the data packet from the destination to the source through the transfer route based on the one or more intermediate network devices;
g. receiving the data packet at the source; and
h. initiating data packet transmission from the source to the destination without the source address, the destination address and the plurality of transport layer addresses.

2. The method of claim 1, wherein the transfer route is determined by transmitting an establish connection packet from the source to the destination or a centralized control plane through the one or more intermediate network devices towards the destination.

3. The method of claim 1, wherein the transfer route is determined by swapping one or more tags from the source to the destination through the one or more intermediate network devices towards the destination.

4. The method of claim 1, wherein the transfer route further comprises but not limited to ports, indices or tags of the one or more intermediate network devices.

5. The method of claim 1, wherein the transport layer address further comprises but not limited to port numbers of network services such as web with the value of 80 or DNS with the value of 53.

6. The method of claim 1, wherein the network can be but not limited to a Local Area Network (LAN), a Wide Area network (WAN), a wireless communications network, a wired communications network or a Radio Access Network.

7. The method of claim 1, wherein the one or more intermediate network devices can be but not limited to network nodes, packet handling devices, switches, ad hoc devices, satellite communication devices or routers.

8. The method of claim 1, wherein the data in the data packet is encrypted at the source and decrypted at the destination.

9. A packet handling system for transmitting data packets/frames between a source and a destination in a network while maintaining security and privacy, comprising:
a memory; and
a processor coupled to the memory and configured to:
a. initiate a transmission session at the source to transmit the data packet to the destination, wherein the data packet contains data, a source address, a destination address and a plurality of transport layer addresses;
b. transmit the data packet to the destination through a transfer route based on one or more intermediate network devices;
c. receive the transmitted data packet at the destination;
d. initiate the transmission session at the destination to transmit back the data packet to the source;
e. remove the source address, the destination address and the plurality of transport layer addresses from the data packet at the destination;
f. transmit back the data packet from the destination to the source through the transfer route based on the one or more intermediate network devices;
g. receive the data packet at the source; and
a. initiate data packet transmission from the source to the destination without the source address, the destination address and the plurality of transport layer addresses.

10. The system of claim 9, wherein the transfer route is determined by transmitting an establish connection packet from the source to the destination or a centralized control plane through the one or more intermediate network devices towards the destination.

11. The system of claim 9, wherein the transfer route is determined by swapping one or more tags from the source to the destination through the one or more intermediate network devices towards the destination.

12. The system of claim 9, wherein the transfer route further comprises but not limited to ports, indices or tags of the one or more intermediate network devices.

13. The system of claim 9, wherein the transport layer address further comprises but not limited to port numbers of network services such as web with the value of 80 or DNS with the value of 53.

14. The system of claim 9, wherein the network can be but not limited to a Local Area Network (LAN), a Wide Area network (WAN), a wireless communications network, a wired communications network or a Radio Access Network.

15. The system of claim 9, wherein the one or more intermediate network devices can be but not limited to network nodes, packet handling devices, switches, ad hoc devices, satellite communication devices or routers.

16. The system of claim 9, wherein the data in the data packet is encrypted at the source and decrypted at the destination.
